(19) United States
(12) Patent Application Publication
(10) Pub. No.: US 2025/0367929 A1
(43) Pub. Date: Dec. 4, 2025

(54) LIQUID EJECTING HEAD AND LIQUID EJECTING APPARATUS

(71) Applicant: SEIKO EPSON CORPORATION, Tokyo (JP)

(72) Inventor: Yusuke MATSUMOTO, SHIOJIRI-SHI (JP)

(21) Appl. No.: 19/218,718

(22) Filed: May 27, 2025

(30) Foreign Application Priority Data
May 30, 2024 (JP) 2024-087765

(51) Int. Cl. B41J 2/14

(52) U.S. Cl. CPC B41J 2/14233; B41J 2002/14306; B41J 2002/14491

(57) ABSTRACT

A liquid ejecting head includes a liquid ejecting section including a plurality of drive elements for causing a plurality of nozzles to eject the liquid, a conductive head cover for exposing the plurality of nozzles to an outside, and a wiring substrate on which an integrated circuit is mounted, in which the wiring substrate includes a first ground wiring that is electrically coupled to the head cover without being electrically coupled to an electrode of the drive element and a second ground wiring that is electrically coupled to the integrated circuit, and the first ground wiring and the second ground wiring are electrically separated from each other in the wiring substrate.

The present application is based on, and claims priority from JP Application Serial Number 2024-087765, filed May 30, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

In the related art, a liquid ejecting head that includes a wiring substrate on which an integrated circuit is mounted and that ejects a liquid such as ink is provided. In order to operate the integrated circuit, it is necessary to set a ground, which is a reference potential. For example, JP-A-2006-88629 discloses a liquid ejecting head in which a screw that functions as a ground of a liquid ejecting head is electrically coupled to a ground section of a printed substrate via a coil spring formed of a conductive material.

In the liquid ejecting head, static electricity may be transmitted from a medium or the like to an ejection surface. In the liquid ejecting head in the related art, there is a concern that the static electricity transmitted to the ejection surface is transmitted to a wiring substrate of the liquid ejecting head, and thus an integrated circuit mounted on the wiring substrate may fail.

### SUMMARY

According to a preferred aspect of the present disclosure, there is provided a liquid ejecting head including: a liquid ejecting section including a plurality of nozzles for ejecting a liquid and a plurality of drive elements for causing the plurality of nozzles to eject the liquid; a conductive head cover for exposing the plurality of nozzles to an outside; and a wiring substrate on which an integrated circuit is mounted, in which the wiring substrate includes a first ground wiring that is electrically coupled to the head cover without being electrically coupled to an electrode of the drive element and a second ground wiring that is electrically coupled to the integrated circuit, and the first ground wiring and the second ground wiring are electrically separated from each other in the wiring substrate.

According to another preferred aspect of the present disclosure, there is provided a liquid ejecting apparatus including: the liquid ejecting head described above; and a generation circuit that generates, from a power supply, a signal of a reference potential that flows through a frame ground that is electrically coupled to at least one of the first ground wiring or the second ground wiring of the liquid ejecting head or at least one wiring of the first ground wiring or the second ground wiring of the liquid ejecting head, which constitutes a part of a signal ground.

### BRIEF DESCRIPTION OF THE DRAWINGS

FIG. 1 is a schematic diagram illustrating a configuration example of a liquid ejecting apparatus.

FIG. 2 is an exploded perspective view of a head module.

FIG. 3 is an exploded perspective view of a liquid ejecting head.

FIG. 4 is a cross-sectional view illustrating a configuration example of a head chip.

FIG. 5 is an enlarged cross-sectional view of a vicinity of a piezoelectric element.

FIG. 6 is an exploded perspective view of a wiring substrate.

FIG. 7 is a cross-sectional view taken along a line VII-VII in FIG. 6.

FIG. 8 is a diagram illustrating a wiring substrate in a first modification example.

FIG. 9 is a diagram illustrating a head module in a second modification example.

FIG. 10 is a diagram illustrating a wiring substrate in a third modification example.

### DESCRIPTION OF EMBODIMENTS

### 1. First Embodiment

Hereinafter, an embodiment for carrying out the present disclosure will be described with reference to the drawings. However, in each of the drawings, a dimension and a scale of each section are varied as appropriate from the actual dimension and scale.

Since the embodiment described below is a preferred specific example of the present disclosure, various technically preferable limitations are given, but the scope of the present disclosure is not limited to these forms unless otherwise specified in the following description to the effect that the present disclosure is limited to this.

For the sake of convenience, the following description will be made by using an X-axis, a Y-axis, and a Z-axis that intersect with each other, as appropriate. In addition, one direction along the X-axis is an X1 direction, and the direction opposite to the X1 direction is an X2 direction. Similarly, directions opposite to each other along the Y-axis are a Y1 direction and a Y2 direction. In addition, directions opposite to each other along the Z-axis are a Z1 direction and a Z2 direction. Here, typically, the Z-axis is a vertical axis, and the Z2 direction corresponds to a down direction in the vertical direction. In other words, the Z2 direction is a gravity direction.

### 1-1. Outline of Liquid Ejecting Apparatus 100

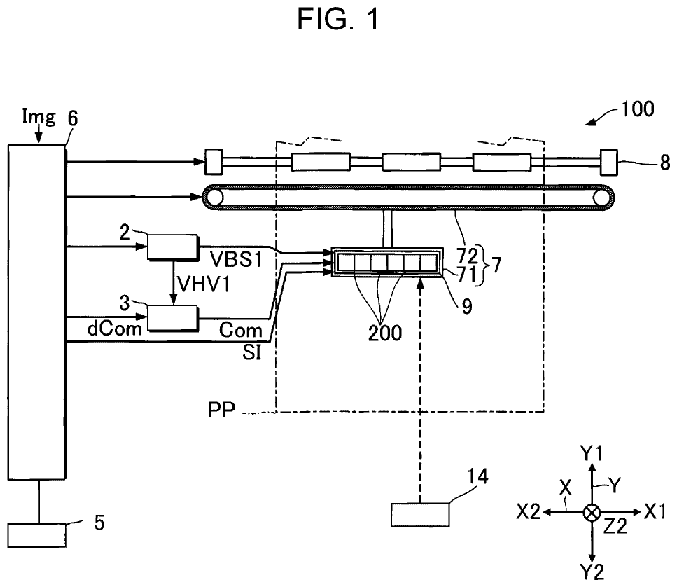

FIG. 1 is a schematic diagram illustrating a configuration example of a liquid ejecting apparatus 100. The liquid ejecting apparatus 100 is an ink jet printing apparatus that ejects an ink, which is an example of a liquid, onto a medium PP in a form of liquid droplets. The medium PP is, for example, printing paper, but any printing target such as a resin film or cloth can be used as the medium PP.

As illustrated in FIG. 1, the liquid ejecting apparatus 100 includes a power supply circuit 2, a drive signal generation circuit 3, a liquid container 14, a storage section 5, a control section 6, a movement mechanism 7, a transport mechanism 8, and a head module 9 including a plurality of liquid ejecting heads 200.

The liquid container 14 is a container for storing the ink. For example, specific aspects of the liquid container 14 include a cartridge attachable to and detachable from the liquid ejecting apparatus 100, a bag-shaped ink pack formed of a flexible film, and an ink tank that can be refilled with the ink. The type of the ink stored in the liquid container 14 is optional.

The storage section 5 is one or a plurality of storage circuits, such as a semiconductor memory. The semiconductor memory is, for example, a non-volatile memory, such as a flash memory. However, the storage section 5 may have a volatile memory, such as a RAM. RAM is an abbreviation for Random Access Memory. Various programs and various data are stored in the storage section 5.

The control section 6 is, for example, one or a plurality of processing circuits, such as a CPU, an SoC, an ASIC, or an FPGA. CPU is an abbreviation for Central Processing Unit. SoC is an abbreviation for System-on-a-chip. ASIC is an abbreviation for Application Specific Integrated Circuit. FPGA is an abbreviation for a Field Programmable Gate Array. The control section 6 executes the program stored in the storage section 5 and implements various types of control by using the data as appropriate.

The transport mechanism 8 transports the medium PP in the Y2 direction under the control of the control section 6. In the example illustrated in FIG. 1, the transport mechanism 8 includes a transport roller that is elongated along the X-axis, and a motor that rotates the transport roller. The configuration of the transport mechanism 8 is not limited to the configuration in which the transport roller is used, and may be, for example, a configuration in which a drum or an endless belt that transports the medium PP by attracting the medium PP to an outer peripheral surface using of an electrostatic force or the like.

The movement mechanism 7 reciprocates the liquid ejecting head 200 in the X1 direction and the X2 direction under the control of the control section 6. In the present embodiment, the X1 direction and the X2 direction are the main scanning directions, and the Y2 direction is a sub-scanning direction. As described above, the liquid ejecting apparatus 100 according to the first embodiment is a serial type liquid ejecting apparatus that reciprocates along the X-axis. As illustrated in FIG. 1, the movement mechanism 7 includes a carriage 71 that accommodates the head module 9, an endless belt 72 to which the carriage 71 is fixed, and a carriage motor (not illustrated) that is a drive source for reciprocating the carriage 71.

The head module 9 ejects the ink supplied from the liquid container 14 in the Z2 direction under the control of the control section 6. One or more liquid ejecting heads 200 are mounted in the head module 9.

The control section 6 drives a piezoelectric element 220f, which will be described below, in order to cause a nozzle N to eject the ink. Specifically, the control section 6 generates a designation signal SI for controlling the liquid ejecting head 200, a signal for controlling the power supply circuit 2, a waveform designation signal dCom for controlling the drive signal generation circuit 3, a signal for controlling the transport mechanism 8, a signal for controlling the movement mechanism 7, or the like.

The power supply circuit 2 receives power from a commercial power supply (not illustrated) and generates signals of various predetermined potentials. The generated various potentials are supplied to each section of the liquid ejecting apparatus 100 as appropriate. For example, the power supply circuit 2 generates a power supply potential signal VHV1 that is a signal of a power supply potential VHV and a reference potential signal VBS1 that is a signal of a reference potential VBS. The reference potential signal VBS1 is supplied to the head module 9. In addition, the power supply potential signal VHV1 is supplied to the drive signal generation circuit 3. The power supply circuit 2 is an example of a “generation circuit”.

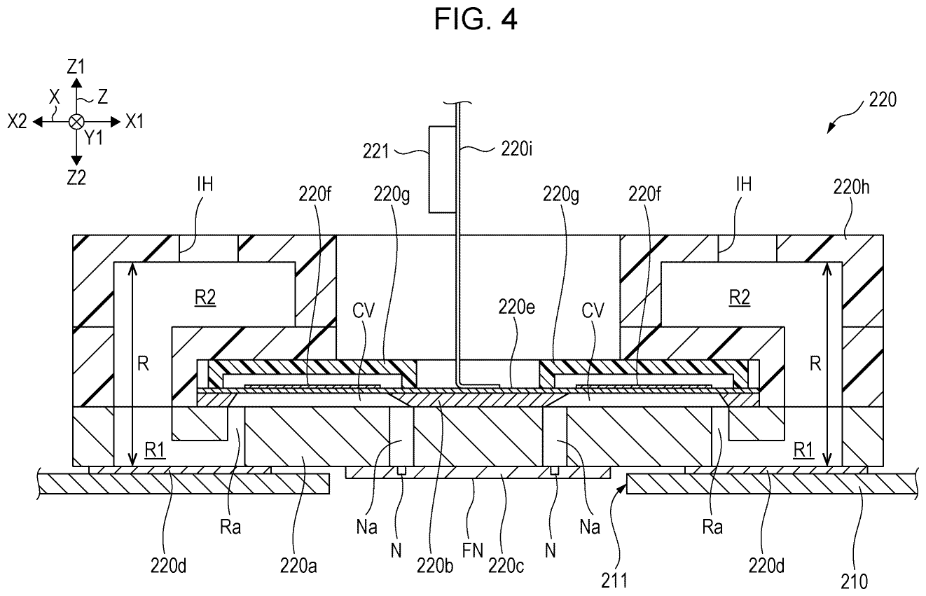

The waveform designation signal dCom is a digital signal that defines a waveform of a drive signal Com. In addition, the drive signal Com is an analog signal for driving the piezoelectric element 220f, which will be described below with reference to FIG. 4. The drive signal generation circuit 3 generates the drive signal Com having the waveform defined by the waveform designation signal dCom, based on the power supply potential signal VHV1. Specifically, the drive signal generation circuit 3 includes, for example, a DA conversion circuit and an amplifier circuit. In the drive signal generation circuit 3, the DA conversion circuit converts the waveform designation signal dCom from the control section 6 from the digital signal to the analog signal, and the amplifier circuit amplifies the analog signal using the power supply potential signal VHV1 from the power supply circuit 2, to generate the drive signal Com. The piezoelectric element 220f is an example of a “drive element”.

The designation signal SI is a digital signal for designating a type of an operation of the piezoelectric element 220f. Specifically, the designation signal SI designates whether or not to supply the drive signal Com to the piezoelectric element 220f, and thereby designating the type of the operation of the piezoelectric element 220f. Here, the designation of the type of operation of the piezoelectric element 220f is, for example, designation of whether or not to drive the piezoelectric element 220f, or designation of whether or not the ink is ejected from the piezoelectric element 220f when the piezoelectric element 220f is driven.

First, when the control section 6 receives a print instruction from a host computer such as a personal computer and a digital camera, the control section 6 stores print data Img included in the print instruction in the storage section 5. Next, the control section 6 generates various control signals such as the designation signal SI, the waveform designation signal dCom, the signal for controlling the transport mechanism 8, and the signal for controlling the movement mechanism 7, based on various data such as the print data Img stored in the storage section 5. The control section 6 controls the liquid ejecting head 200 such that the piezoelectric element 220f is driven, while controlling the transport mechanism 8 and the movement mechanism 7 to change a relative position of the medium PP with respect to the liquid ejecting head 200 based on various control signals and various data stored in the storage circuit of the control section 6. As a result, the control section 6 adjusts the presence or absence of the ink ejection from the piezoelectric element 220f, an ink ejection amount, an ink ejection timing, and the like, and controls the execution of the printing operation of forming an image corresponding to the print data Img on the medium PP.

### 1-2. Head Module 9

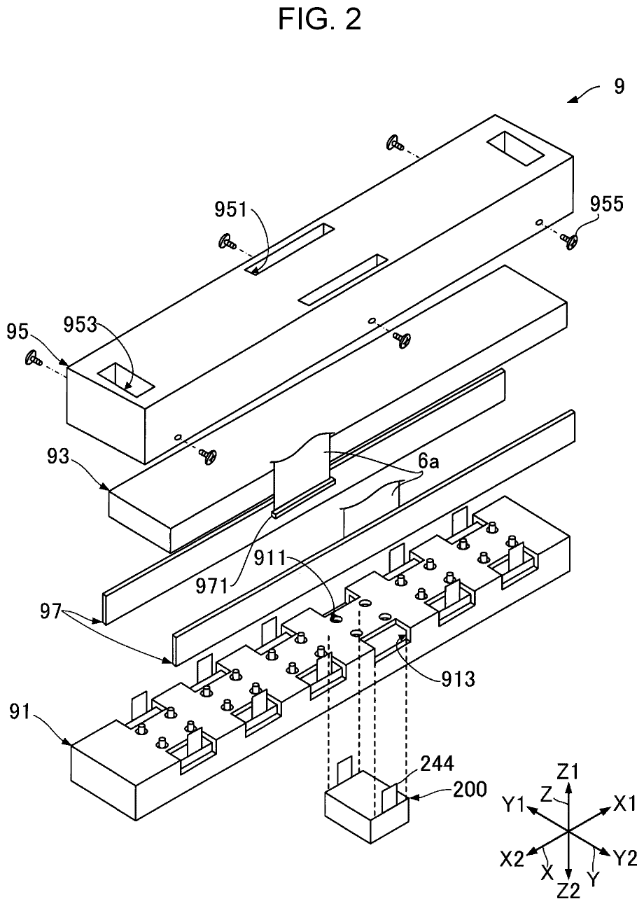

FIG. 2 is an exploded perspective view of the head module 9. In FIG. 2, a shape of the liquid ejecting head 200 is simplified and illustrated in order to prevent the drawing from being complicated. The head module 9 includes a plurality of liquid ejecting heads 200, a base 91, a distribution flow path member 93, and a base cover 95.

The base 91 is a member that holds the plurality of liquid ejecting heads 200. The base 91 is provided with a space that is open in the Z2 direction, and the plurality of liquid ejecting heads 200 are accommodated in the space. The base 91 is formed of a conductive material such as metal.

In the examples illustrated in FIGS. 1 and 2, six liquid ejecting heads 200 are held by the base 91, but the number of the liquid ejecting heads 200 is not particularly limited, and may be one or two or more.

In addition, the base 91 is provided with a supply hole 911 that penetrates along the Z-axis. A flow path of the liquid ejecting head 200 fixed to the base 91 is exposed on a surface facing the Z1 direction by the supply hole 911, and the distribution flow path member 93 is coupled to the flow path exposed by the supply hole 911.

Further, the base 91 is provided with a wiring member opening section 913 for inserting a wiring member 244 of the liquid ejecting head 200. In the present embodiment, the wiring member opening sections 913 are provided for each of the liquid ejecting heads 200 at an end portion in the Y1 direction and an end portion in the Y2 direction. That is, two wiring member opening sections 913 are provided in total for each liquid ejecting head 200. The wiring member 244 of the liquid ejecting head 200 fixed in the space of the base 91 through the wiring member opening section 913 is led in the Z1 direction of the base 91.

A relay substrate 97 is attached to each of a wall surface of the base 91 facing the Y1 direction and a wall surface thereof facing the Y2 direction. The wiring member 244 is electrically coupled to the relay substrate 97. In the present embodiment, the relay substrate 97 has a length along the X-axis over a plurality of liquid ejecting heads 200, in the present embodiment, six liquid ejecting heads 200. In addition, the two relay substrates 97 are arranged in parallel along the Y-axis.

Further, the relay substrate 97 includes a connector 971, and a control cable 6a from the control section 6 is detachably coupled to the connector 971. In the present embodiment, one control cable 6a is coupled to each relay substrate 97. The number of the control cables 6a is not limited, and may be two or more. The control cable 6a is formed of a flexible substrate. The control cable 6a is, for example, a flexible substrate such as a COF, an FPC, or an FFC. COF is an abbreviation for Chip On Film. FPC is an abbreviation for flexible Printed Circuits. FFC is an abbreviation for Flexible Flat Cable.

The distribution flow path member 93 is a member that distributes and supplies the ink, which is supplied from the liquid container 14, to each liquid ejecting head 200. Inside the distribution flow path member 93 (not illustrated), a distribution flow path for distributing and supplying the ink, which is supplied from the liquid container 14 and is supplied for each color or for each of different colors, to the liquid ejecting head 200. The base cover 95 is provided with a control cable opening section 953 for

inserting the control cable 6a. The control cable 6a is inserted through a control cable opening section 951, and is coupled to the internal relay substrate 97. In the present embodiment, the base cover 95 is formed of a conductive material such as metal. The base cover 95 is fixed to the base 91 by a conductive screw member 955 such as metal. The base cover 95 is coupled to a housing of the liquid ejecting apparatus 100 by a conductive spring (not illustrated) formed of metal.

### 1-3. Configuration of Liquid Ejecting Head 200

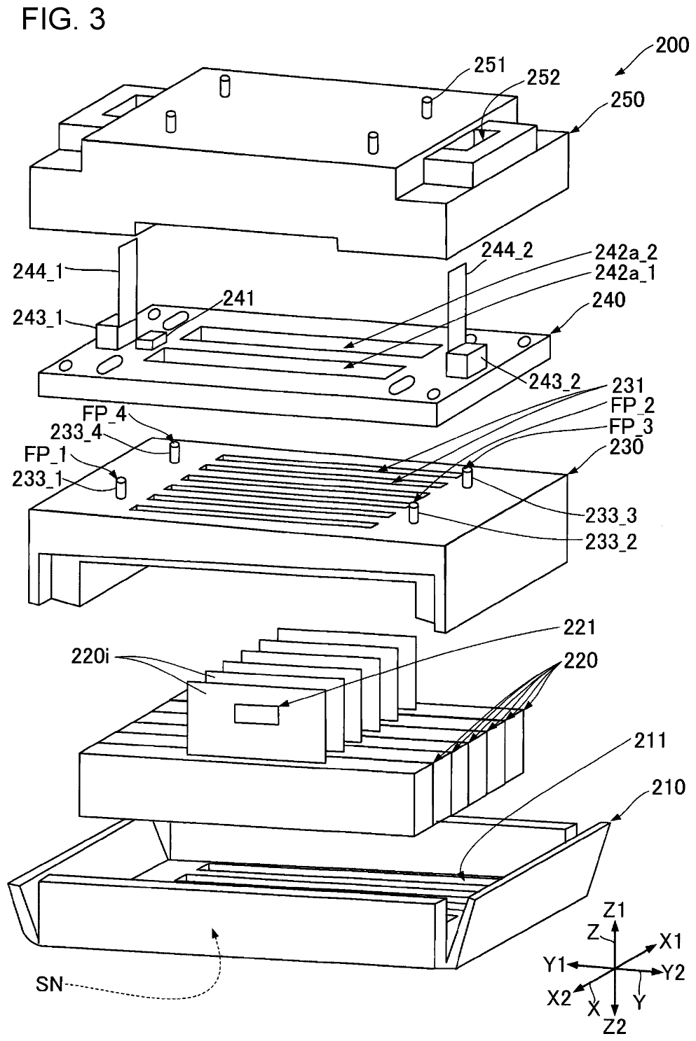

FIG. 3 is an exploded perspective view of the liquid ejecting head 200. The liquid ejecting head 200 includes a head cover 210, six head chips 220, six drive circuits 221, a holder 230, a wiring substrate 240, and a flow path member 250. As illustrated in FIG. 3, the head cover 210, the six head chips 220, the holder 230, the wiring substrate 240, and the flow path member 250 are stacked in this order along the Z-axis. The six head chips 220 correspond to a “liquid ejecting section”.

One head chip 220 includes a plurality of nozzles N. In the present embodiment, the plurality of nozzles N included in one head chip 220 form two nozzle rows. However, the number of the head chips 220 included in the liquid ejecting head 200 is not limited to six, and need only be two or more. In addition, the number of the nozzle rows included in the head chip 220 is not limited to two, and may be one. The head chip 220 will be described with reference to FIG. 4.

FIG. 4 is a cross-sectional view illustrating a configuration example of the head chip 220. However, in FIG. 4, in addition to the head chip 220, a part of the drive circuit 221 and the head cover 210 is also illustrated.

As illustrated in FIG. 4, the head chip 220 includes the plurality of nozzles N arranged in a direction along the Y-axis. As illustrated in FIG. 4, the plurality of nozzles N are divided into the two nozzle rows arranged at intervals in a direction along the X-axis. Each of the two nozzle rows is a set of the nozzles N arranged linearly in the direction along the Y-axis.

The head chip 220 has a configuration substantially symmetrical with each other in the direction along the X-axis. However, the positions of the nozzles N of one nozzle row of the two nozzle rows and the nozzles N of the other nozzle row in the direction along the Y-axis may be the same as each other or different from each other.

As illustrated in FIG. 4, the head chip 220 includes a flow path substrate 220a, a pressure chamber substrate 220b, a nozzle plate 220c, a vibration absorbing body 220d, a vibration plate 220e, a plurality of piezoelectric elements 220f, a protection plate 220g, a case 220h, and a wiring member 220i.

The flow path substrate 220a and the pressure chamber substrate 220b are stacked in this order in the Z1 direction, and form a flow path for supplying the ink to the plurality of nozzles N. The vibration plate 220e, the plurality of piezoelectric elements 220f, the protection plate 220g, the case 220h, and the wiring member 220i are installed in a region located in the Z1 direction with respect to a laminate formed by the flow path substrate 220a and the pressure chamber substrate 220b. On the other hand, the nozzle plate 220c and the vibration absorbing body 220d are installed in a region located in the Z2 direction with respect to the laminate. The respective elements of the head chip 220 are schematically plate-shaped members elongated in the Y direction, and are joined to each other with, for example, an adhesive. Hereinafter, each of the elements of the head chip 220 will be described in order.

The nozzle plate 220c is a plate-shaped member provided with the plurality of nozzles N. Each of the plurality of nozzles N is a through-hole through which the ink passes. Here, a surface of the nozzle plate 220c facing the Z2 direction is a nozzle surface FN. The nozzle plate 220c is manufactured by, for example, processing a silicon single crystal substrate by a semiconductor manufacturing technique using a processing technique such as dry etching or wet etching. Here, other known methods and materials may be used as appropriate for manufacturing the nozzle plate 220c. In addition, although a cross-sectional shape of the nozzle N is typically circular, the cross-sectional shape is not limited to this, and may be, for example, a non-circular shape such as a polygonal or elliptical shape.

The flow path substrate 220a is provided with a space R1, a plurality of supply flow paths Ra, and a plurality of communication flow paths Na for each of the two nozzle rows. The space R1 is an elongated opening extending in the direction along the Y-axis in plan view in a direction along the Z-axis. Each of the supply flow path Ra and the communication flow path Na is a through-hole formed for each nozzle N. Each supply flow path Ra communicates with the space R1.

The pressure chamber substrate 220b is a plate-shaped member provided with a plurality of pressure chambers CV, which are referred to as cavities, for each of the two nozzle rows. The plurality of pressure chambers CV are arranged in the direction along the Y-axis. Each pressure chamber CV is an elongated space formed for each nozzle N and extending in the direction along the X-axis in plan view. Each of the flow path substrate 220a and the pressure chamber substrate 220b is manufactured by, for example, processing a silicon single crystal substrate by a semiconductor manufacturing technique in the same manner as the nozzle plate 220c described above. Here, other known methods and materials may be used as appropriate for manufacturing each of the flow path substrate 220a and the pressure chamber substrate 220b.

The pressure chamber CV is a space located between the flow path substrate 220a and the vibration plate 220e. The plurality of pressure chambers CV are arranged in the direction along the Y-axis for each of the two nozzle rows. In addition, the pressure chamber CV communicates with each of the communication flow path Na and the supply flow path Ra. Therefore, the pressure chamber CV communicates with the nozzle N through the communication flow path Na, and communicates with the space R1 through the supply flow path Ra.

The vibration plate 220e is disposed on a surface of the pressure chamber substrate 220b facing the Z1 direction. The vibration plate 220e is a plate-shaped member that can elastically vibrate. The vibration plate 220e has, for example, a first layer and a second layer, and the first layer and the second layer are stacked in this order in the Z1 direction. The first layer is, for example, an elastic film made of silicon oxide. The elastic film is formed by, for example, thermally oxidizing one surface of the silicon single crystal substrate. The second layer is, for example, an insulating film made of zirconium oxide. The insulating film is formed by, for example, forming a zirconium layer using a sputtering method and thermally oxidizing the formed layer. The vibration plate 220e is not limited to the above-described configuration in which the first layer and the second layer are stacked, and may be composed of, for example, a single layer or three or more layers.

The plurality of piezoelectric elements 220f that correspond to the nozzles N are disposed on a surface of the vibration plate 220e facing the Z1 direction for each of the two nozzle rows. Each piezoelectric element 220f is a passive element deformed in response to the supply of the drive signal Com. Each piezoelectric element 220f has an elongated shape extending in the direction along the X-axis in plan view. The plurality of piezoelectric elements 220f are arranged in the direction along the Y-axis to correspond to the plurality of pressure chambers CV. The piezoelectric element 220f overlaps the pressure chamber CV in plan view.

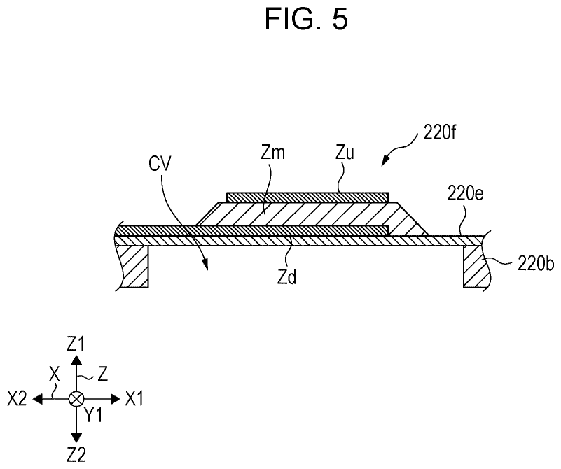

FIG. 5 is an enlarged cross-sectional view of the vicinity of the piezoelectric element 220f. However, in FIG. 5, the illustration of the protection plate 220g is omitted in order to prevent the drawing from being complicated.

As illustrated in FIG. 5, the piezoelectric element 220f is a laminate in which a piezoelectric body Zm is interposed between an upper electrode Zu to which the reference potential signal VBS1 is supplied and a lower electrode Zd to which the drive signal Com is supplied. The piezoelectric element 220f is, for example, a part in which the lower electrode Zd, the upper electrode Zu, and the piezoelectric body Zm overlap each other when viewed in the Z1 direction. In addition, the pressure chamber CV is provided in the Z2 direction of the piezoelectric element 220f. In the first embodiment, the reference potential signal VBS1 is supplied to the upper electrode Zu, and the drive signal Com is supplied to the lower electrode Zd, but the reference potential signal VBS1 may be supplied to the upper electrode Zu, and the drive signal Com may be supplied to the lower electrode Zd.

The description will return to FIG. 4. The protection plate 220g is a plate-shaped member installed on the surface of the vibration plate 220e facing the Z1 direction, and protects the plurality of piezoelectric elements 220f and reinforces the mechanical strength of the vibration plate 220e. Here, the plurality of piezoelectric elements 220f are accommodated between the protection plate 220g and the vibration plate 220e. The protection plate 220g is made of, for example, a resin material.

The case 220h is a member for storing the ink supplied to the plurality of pressure chambers CV. The case 220h is made of, for example, a resin material. The case 220h is provided with a space R2 for each of the two nozzle rows. The space R2 is a space that communicates with the above-described space R1, and functions as a reservoir R for storing the ink supplied to the plurality of pressure chambers CV together with the space R1. The case 220h is provided with an introduction port IH for supplying the ink to each reservoir R. The ink in each reservoir R is supplied to the pressure chamber CV through each supply flow path Ra.

The vibration absorbing body 220d is also referred to as a compliance substrate, is a flexible resin film constituting a wall surface of the reservoir R, and absorbs pressure fluctuations of the ink in the reservoir R. The vibration absorbing body 220d may be a thin plate formed of metal and having flexibility. A surface of the vibration absorbing body 220d facing the Z1 direction is joined to the flow path substrate 220a with an adhesive or the like.

The wiring member 220i is a mounting component that is mounted on the surface of the vibration plate 220e facing the Z1 direction, and that electrically couples the head chip 220, the drive circuit 221, the control section 6, and the like. The wiring member 220i is, for example, a flexible wiring substrate such as a COF, an FPC, or an FFC. The drive circuit 221 described above is mounted in the wiring member 220i of the present embodiment. COF is an abbreviation for Chip On Film. FPC is an abbreviation for Flexible Printed Circuit. FFC is an abbreviation for Flexible Flat Cable. The wiring member 220i electrically couples the piezoelectric element 220f and the wiring substrate 240.

The drive circuit 221 drives the plurality of piezoelectric elements 220f under the control of the control section 6. The drive circuit 221 includes a switching element that switches whether or not to supply the drive signal Com to each of the plurality of piezoelectric elements 220f.

The description will return to FIG. 3. The head cover 210 is a member for exposing the plurality of nozzles N to the outside. As illustrated in FIG. 3, the head cover 210 includes a conductive member formed of a conductive material such as metal, and a plate-shaped member formed of stainless steel.

The head cover 210 is provided in common to the plurality of head chips 220. It goes without saying that the head cover 210 is not limited to the configuration in which the head cover 210 is provided in common to all the head chips 220 provided in one liquid ejecting head 200, and the head cover 210 may be provided independently for each head chip 220, or may be provided independently for each group including a plurality of head chips 220, that is, two or more head chips 220. However, as in the present embodiment, by providing the head cover 210 in common to all the head chips 220 constituting one liquid ejecting head 200 and fixing the head chips 220 to the head cover 210, the head cover 210 can be used when the relative positioning of the nozzle openings of the plurality of head chips 220 is performed, and the positioning of the nozzle surfaces FN of the plurality of head chips 220 in the direction along the Z-axis can be performed with high accuracy.

The head cover 210 is provided with an exposure opening section 211 for exposing the plurality of nozzles N to the outside. In the present embodiment, the exposure opening section 211 is provided to be independently open for each head chip 220. Since the liquid ejecting head 200 of the present embodiment includes the six head chips 220, six independent exposure opening sections 211 are provided. However, depending on the configuration of the head chip 220 or the like, one common exposure opening section 211 may be provided for a group including the plurality of head chips 220. A surface of the head cover 210 facing the Z2 direction is a surface facing the medium PP. Hereinafter, the surface of the head cover 210 facing the Z2 direction may be referred to as an ejection surface SN. The nozzle surface FN may be included in the ejection surface SN.

The holder 230 is fixed to a surface of the flow path member 250 facing the Z2 direction. The holder 230 forms a groove-shaped space facing the Z2 direction. In this space, the plurality of head chips 220 are provided in parallel along the X-axis.

The holder 230 is provided with a first wiring member opening section 231 for inserting the wiring member 220i of each of the six head chips 220. The first wiring member opening section 231 is provided to be independently open for each wiring member 220i. Since the liquid ejecting head 200 of the present embodiment includes the six head chips 220, six independent first wiring member opening sections 231 are provided. However, depending on the configuration of the head chip 220 or the like, one common first wiring member opening section 231 may be provided for a group including the plurality of head chips 220.

Further, four coupling pipes 233 are provided on the surface of the holder 230 facing the Z1 direction. The coupling pipe 233 is a pipe body protruding from the surface facing the Z1 direction. The coupling pipe 233 is provided with a flow path for supplying the ink supplied from the liquid container 14 to the head chip 220. Although not provided in the present embodiment, a flow path for discharging the ink from the head chip 220 may be provided in the coupling pipe 233.

The wiring substrate 240 is a mounting component for electrically coupling the liquid ejecting head 200 to the control section 6. An integrated circuit 241 is mounted on a surface of the wiring substrate 240 facing the Z1 direction. The integrated circuit 241 is, for example, a memory, but may be other than the memory. Further, the wiring substrate 240 is provided with a second wiring member opening section 242a for inserting the wiring member 220i. In the present embodiment, the wiring substrate 240 is provided with two second wiring member opening sections 242a, which are a second wiring member opening section 242a_1 and a second wiring member opening section 242a_2, and two wiring members 220i are inserted into one second wiring member opening section 242a. The second wiring member opening section 242a_1 is located in the X2 direction with respect to the second wiring member opening section 242a_2.

Further, the wiring substrate 240 includes two connectors 243, a connector 243_1 and a connector 243_2, on the surface facing the Z1 direction. The connector 243_1 is provided at an end portion of the wiring substrate 240 in the Y1 direction. The connector 243_2 is provided at an end portion of the wiring substrate 240 in the Y2 direction. The wiring member 244_1 is detachably coupled to the connector 243_1. The wiring member 244_2 is detachably coupled to the connector 243_2. Hereinafter, the connector 243_1 and the connector 243_2 may be referred to as a connector 243 without distinction. The two wiring members 244 are formed of a flexible substrate. The description of the wiring substrate 240 will be described in detail below.

An inner portion (not illustrated) of the flow path member 250 is provided with a flow path for supplying the ink supplied from the distribution flow path member 93 to the head chip 220. The flow path is provided on a surface of the flow path member 250 facing the Z1 direction, and is provided to be open to a tip end surface of a protrusion section 251 protruding in the Z1 direction. In the present embodiment, four protrusion sections 251 are provided on the surface of the flow path member 250 facing the Z2 direction. A filter for removing foreign matters, such as dust and air bubbles, contained in the ink may be provided in the middle of the flow path in the flow path member 250.

In addition, the flow path member 250 is provided with a cable insertion hole 252 penetrating along the Z-axis at each of an end portion in the Y1 direction and an end portion in the Y2 direction. The wiring member 244 into which the cable insertion hole 252 is inserted from the Z2 direction of the flow path member 250 is coupled to the wiring substrate 240 held between the flow path member 250 and the holder 230. The two wiring members 244 are formed of a flexible substrate. The wiring member 244 is, for example, a flexible substrate such as a COF, an FPC, or an FFC.

### 1-4. Static Electricity Generated During Printing Operation

When the printing operation is executed, the static electricity may be transferred to the ejection surface SN from the medium PP. There is a concern that the integrated circuit 241 may fail when the static electricity, which is transmitted to ejection surface SN, is transmitted to the integrated circuit 241 of the wiring substrate 240 through the head cover 210.

Therefore, in the present embodiment, the wiring substrate 240 includes a grounding ground wiring GND1 for being electrically coupled to the head cover 210, and a normal ground wiring GND2 for being electrically coupled to the integrated circuit 241. In the wiring substrate 240, the grounding ground wiring GND1 and the normal ground wiring GND2 are electrically separated from each other. The grounding ground wiring GND1 is an example of a “first ground wiring”. The normal ground wiring GND2 is an example of a “second ground wiring”.

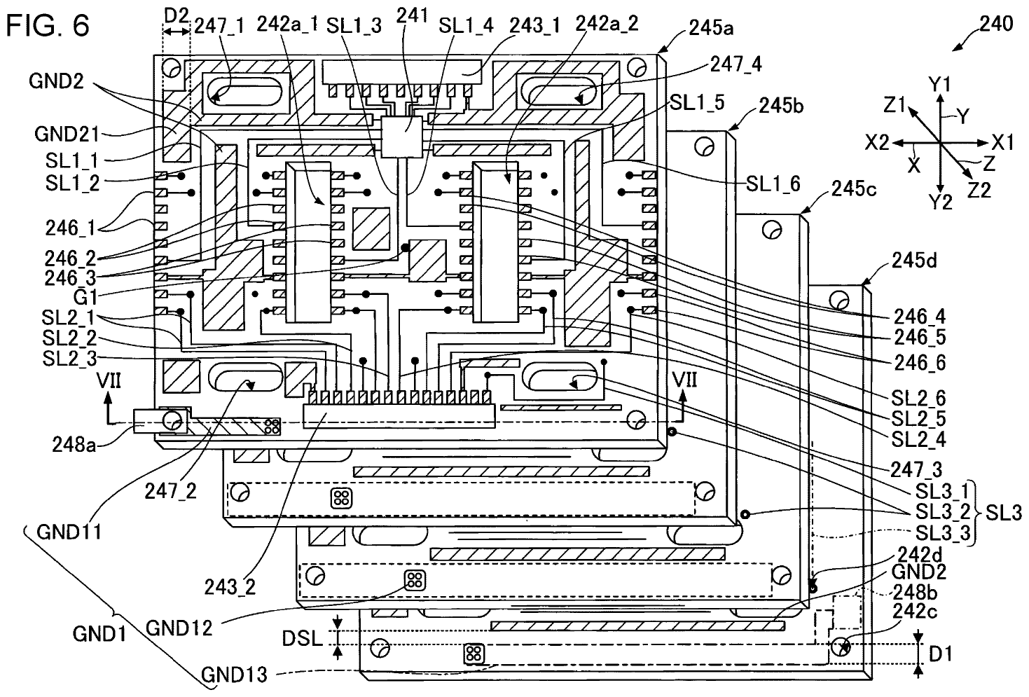

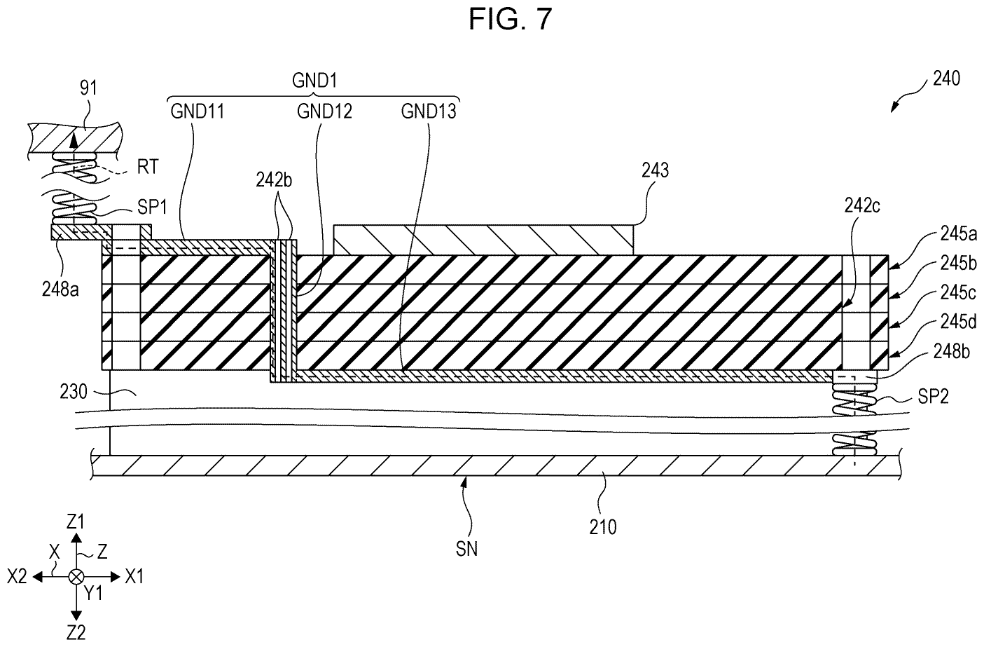

In the present specification, the phrase “the constituent element 1 and the constituent element 2 are electrically coupled to each other” means that the constituent element 1 and the constituent element 2 are directly coupled to each other in a state where the power can be supplied, and that the constituent element 1 and the constituent element 2 are indirectly coupled to each other through a conductor in a state where the power can be supplied. In addition, the phrase “the constituent element 1 and the constituent element 2 are electrically separated from each other” means that the constituent element 1 and the constituent element 2 are not electrically coupled to each other. However, when the constituent element 1 and the constituent element 2 are indirectly coupled to each other through the conductor, the volume of the conductor is sufficiently large, and the constituent element 1 and the constituent element 2 substantially do not affect each other, the constituent element 1 and the constituent element 2 are treated as being electrically separated from each other. The phrase “the constituent element 1 and the constituent element 2 substantially do not affect each other” means that a potential change of the constituent element 2 is substantially not caused by a current change of the constituent element 1, and a potential change of the constituent element 1 is substantially not caused by a current change of the constituent element 2. In addition, the phrase “the potential change is substantially not caused” includes a case where it is regarded that there is no potential change when an error is taken into consideration, in addition to a case where the potential is not changed at all. Hereinafter, the wiring substrate 240 will be described with reference to FIGS. 6 and 7.

### 1-5. Configuration of Wiring Substrate 240

FIG. 6 is an exploded perspective view of the wiring substrate 240. FIG. 7 is a cross-sectional view taken along a line VII-VII in FIG. 6. The line VII-VII is a line segment parallel to the X-axis. In FIG. 7, in addition to the wiring substrate 240, a part of the holder 230, a part of the head cover 210, and a part of the base 91 are also illustrated. The wiring substrate 240 has a substantially rectangular shape when viewed in the direction along the Z-axis. The direction along the Z-axis is also a thickness direction of the wiring substrate 240. As illustrated in FIGS. 6 and 7, the wiring substrate 240 is formed by stacking a first insulator layer 245a, a second insulator layer 245b, a third insulator layer 245c, and a fourth insulator layer 245d in this order along the Z-axis. Hereinafter, the first insulator layer 245a, the second insulator layer 245b, the third insulator layer 245c, and the fourth insulator layer 245d may be referred to as an insulator layer 245 without distinction. The four insulator layers 245 may be formed of one type of insulator, or may be formed of two or more types of insulators. The wiring substrate 240 is a multilayer substrate including the four insulator layers 245. The number of the insulator layers 245 included in the wiring substrate 240 is not limited to four, and need only be three or more. The four insulator layers 245 are an example of “three or more insulator layers”.

The wiring substrate 240 includes six terminal groups 246, 12 or more signal wirings SL, the grounding ground wiring GND1, the normal ground wiring GND2, and four flow path opening sections 247 in addition to the integrated circuit 241, the two second wiring member opening sections 242a, and the two connectors 243.

The six terminal groups 246 are directly coupled to the terminal of the wiring member 220i in the Z1 direction in a state where the power can be supplied. The six terminal groups 246 are provided on a surface of the first insulator layer 245a facing the Z1 direction. The six terminal groups 246 include a terminal group 246_1, a terminal group 246_2, a terminal group 246_3, a terminal group 246_4, a terminal group 246_5, and a terminal group 246_6. Among the six terminal groups 246, two terminal groups 246 are disposed along a side of the wiring substrate 240 in the X1 direction and a side thereof in the X2 direction, and the remaining four terminal groups 246 are disposed along a side of each of the two second wiring member opening sections 242a in the X1 direction and a side thereof in the X2 direction. Specifically, the terminal group 246_1 is disposed along a side of the wiring substrate 240 in the X2 direction. The terminal group 246_2 is disposed along a side of the second wiring member opening section 242a_1 in the X2 direction. The terminal group 246_3 is disposed along a side of the second wiring member opening section 242a_1 in the X1 direction. The terminal group 246_4 is disposed along a side of the second wiring member opening section 242a_2 in the X2 direction. The terminal group 246_5 is disposed along a side of the second wiring member opening section 242a_1 in the X1 direction. The terminal group 246_6 is disposed along a side of the wiring substrate 240 in the X2 direction.

The 12 or more signal wirings SL are wirings for transmitting an electric signal between the constituent elements of the wiring substrate 240. The 12 or more signal wirings SL include, for example, a signal wiring SL1_i and a signal wiring SL2_i for each of the integers i from 1 to 6. The signal wiring SL1_i is a wiring for transmitting an electric signal between one or more terminals of the terminal group 246_i and the integrated circuit 241. The signal wiring SL2_i is a wiring for transmitting an electric signal between one or more terminals of the terminal group 246_i and the connector 243_2. The 12 or more signal wirings SL are an example of a “plurality of signal wirings”.

The signal wiring SL included in the wiring substrate 240 may be disposed between two insulator layers 245 adjacent to each other among the four insulator layers 245.

The grounding ground wiring GND1 is a ground wiring for being electrically coupled to the frame ground outside the liquid ejecting head 200. The normal ground wiring GND2 is a wiring for constituting a part of the signal ground. The signal ground is a potential that is a reference for an operation of an electronic circuit. The frame ground is a potential that is most stable and easy to be used as a reference when adjusting the potential between the components of the equipment, and is a potential that is coupled to a metal skeleton part. The frame ground outside the liquid ejecting head 200 is, for example, the base 91. In the present embodiment, the frame ground outside the liquid ejecting head 200 will be described as the base 91. The normal ground wiring GND2 may be electrically coupled to the frame ground. In other words, the grounding ground wiring GND1 and the normal ground wiring GND2 may be indirectly coupled to each other through the frame ground. This is because, even when the grounding ground wiring GND1 and the normal ground wiring GND2 are indirectly coupled to each other through the frame ground, the volume of the conductor that serves as the frame ground is sufficiently large, and the condition in which the grounding ground wiring GND1 and the normal ground wiring GND2 are electrically separated from each other is satisfied.

The grounding ground wiring GND1 is provided at an end portion of the wiring substrate 240 in the Y2 direction. As illustrated in FIGS. 6 and 7, in the wiring substrate 240, the grounding ground wiring GND1 has a wiring part GND11, a through-hole wiring GND12, and a wiring part GND13.

The wiring part GND11 is disposed along the X-axis on a surface of the first insulator layer 245a facing the Z1 direction. In FIG. 6, the wiring part GND11 is shaded with oblique lines from an upper left to a lower right. The wiring part GND11 is directly coupled to a grounding spring abutting section 248a at an end portion in the X2 direction in a state where the power can be supplied. The grounding spring abutting section 248a is formed of a conductive material. The grounding spring abutting section 248a abuts on a grounding spring SP1 disposed along the Z-axis on the surface facing the Z1 direction. The grounding spring SP1 is formed of a conductive material. Although not illustrated in FIG. 6, the grounding spring SP1 abuts on the base 91 at an end portion of the grounding spring SP1 in the Z1 direction. The wiring part GND11 is directly coupled to the through-hole wiring GND12 at an end portion in the X1 direction in a state where the power can be supplied. The grounding spring SP1 is an example of a “conductive member that electrically couples the first ground wiring and the frame ground”.

The through-hole wiring GND12 is disposed along a through-hole 242b penetrating the wiring substrate 240, specifically, the four insulator layers 245 along the Z-axis. The through-hole is a through-hole penetrating the multilayer substrate, and is provided between the plurality of insulator layers included in the multilayer substrate or between two wirings provided on any of both surfaces of the multilayer substrate to make the two wirings conductive. Further, the through-hole can also be used for inserting a lead component. At an end portion of the through-hole wiring GND12 in the Z2 direction, the through-hole wiring GND12 is directly coupled to the wiring part GND13 in a state where the power can be supplied.

The wiring part GND13 is disposed substantially along the X-axis on a surface of the fourth insulator layer 245d facing the Z2 direction. In FIG. 6, since the wiring substrate 240 is viewed in the Z2 direction, the wiring part GND13 is not visible, but the wiring part GND13 is displayed by a one-dot chain line for the sake of convenience. As illustrated in FIGS. 6 and 7, at an end portion of the wiring part GND13 in the X1 direction, the wiring part GND13 is bent in the Y1 direction to avoid a riveting through-hole 242c provided in the vicinity of the apex of the wiring substrate 240 when viewed along the Z-axis. Further, an end portion of the wiring part GND13 in the X1 direction is directly coupled to the grounding spring abutting section 248b in a state where the power can be supplied. The grounding spring abutting section 248b is formed of a conductive material. The grounding spring abutting section 248b is disposed on the surface of the fourth insulator layer 245d facing the Z2 direction. In FIG. 6, since the wiring substrate 240 is viewed in the Z2 direction, the grounding spring abutting section 248b is not visible, but the grounding spring abutting section 248b is displayed by a one-dot chain line for the sake of convenience. The grounding spring abutting section 248b abuts on the grounding spring SP2 disposed along the Z-axis on the surface facing the Z2 direction. The grounding spring SP2 is formed of a conductive material. Although not illustrated in FIG. 7, an end portion of the grounding spring SP2 in the Z2 direction abuts on the head cover 210.

As illustrated in FIG. 7, the grounding spring SP2 abuts on the head cover 210 through the outside of the holder 230, specifically, a wall surface of the holder 230 in the Y2 direction. Although not illustrated, the grounding spring SP1 also abuts on the base 91 through the outside of the flow path member 250.

The reference potential signal VBS1, which is supplied from the power supply circuit 2, is supplied to the normal ground wiring GND2. In FIG. 6, the normal ground wiring GND2 is shaded with oblique lines from an upper right to a lower left. The reference potential signal VBS1 is an example of a “signal of a reference potential that flows through a signal ground”. The normal ground wiring GND2 is electrically coupled to the integrated circuit 241. Further, the normal ground wiring GND2 is electrically coupled to the upper electrode Zu of the piezoelectric element 220f. Further, the normal ground wiring GND2 is electrically coupled to the drive circuit 221. However, the grounding ground wiring GND1 is not electrically coupled to the drive circuit 221.

As illustrated in FIG. 6, the normal ground wiring GND2 has a wiring part GND21 having a width D2 larger than a width D1 of the grounding ground wiring GND1. In addition, a maximum width of the normal ground wiring GND2 is larger than a maximum width of the grounding ground wiring GND1. In other words, when viewed in the Z-axis direction, an area of the normal ground wiring GND2 is larger than an area of the grounding ground wiring GND1.

It is preferable that the grounding ground wiring GND1 and the 12 or more signal wirings SL and the normal ground wiring GND2 are disposed away from each other, and it is preferable to avoid vias. Specifically, as understood from FIG. 6, the grounding ground wiring GND1 does not overlap the 12 or more signal wirings SL and the normal ground wiring GND2 in plan view. Further, a wiring, which is adjacent to the grounding ground wiring GND1, among the 12 or more signal wirings SL and the normal ground wiring GND2 is the normal ground wiring GND2 disposed on the surface of the fourth insulator layer 245d in the Z1 direction. A shortest distance D1 between the normal ground wiring GND2 and the grounding ground wiring GND1 is 4 mm or more.

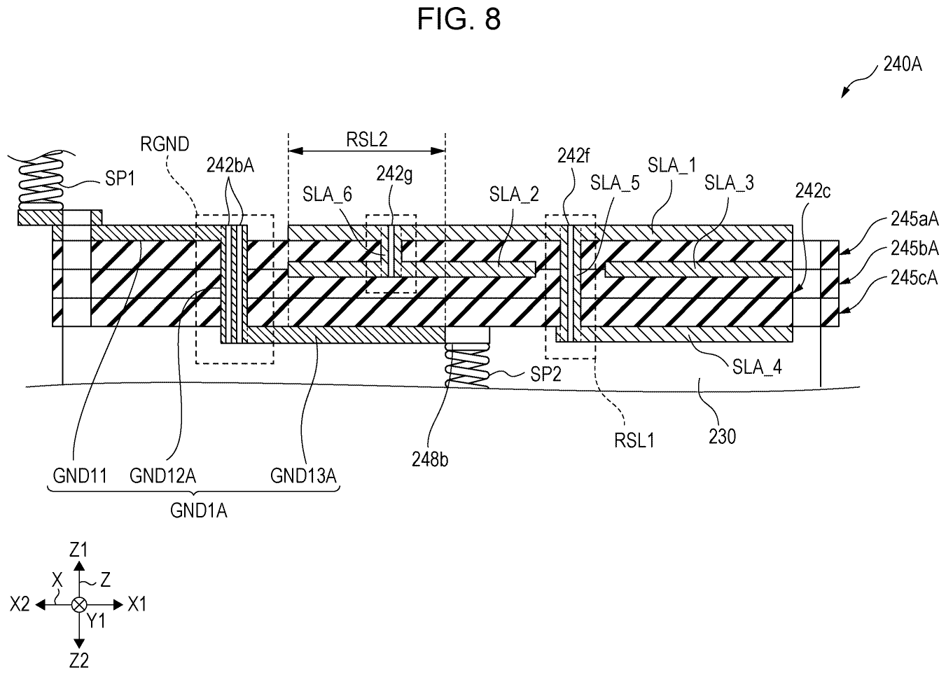

As illustrated in FIG. 8, the wiring substrate 240 includes the four flow path opening sections 247. The four flow path opening sections 247 are through-holes penetrating along the direction along the Z-axis. Specifically, the four flow path opening sections 247 are provided in the vicinity of the apex of the wiring substrate 240 in plan view. The four flow path opening sections 247 are a flow path opening section 247_1 provided at an end portion in the X2 direction and the Y1 direction, a flow path opening section 247_2 provided at an end portion in the X2 direction and the Y2 direction, a flow path opening section 247_3 provided at an end portion in the X1 direction and the Y2 direction, and a flow path opening section 247_4 provided at an end portion in the X1 direction and the Y1 direction. As illustrated in FIG. 6, the flow path opening section 247_2 is disposed between the wiring part GND11, which is a part of the grounding ground wiring GND1, and the signal wiring SL2_3 in plan view. The flow path opening section 247_2 corresponds to a “through-hole”.

One of the four coupling pipes 233 included in the holder 230 is inserted into each of the four flow path opening sections 247. Specifically, the coupling pipe 233_i is inserted into the flow path opening section 247_i for each of the integers of i from 1 to 4. Further, for each of the integers of i from 1 to 4, a space inside the coupling pipe 233_i is the coupling flow path FP_i through which the six head chips 220 and the flow path member 250 communicate with each other. The coupling flow path FP_2 is an example of a “coupling flow path” disposed inside the flow path opening section 247_2.

In the present embodiment, the coupling pipe 233 protruding in the Z1 direction is coupled to each of the four flow path opening sections 247, but the present disclosure is not limited to this, and the flow path member 250 may have a coupling pipe protruding in the Z2 direction, and the coupling pipe may be inserted into each of the flow path opening sections 247. Alternatively, the member inserted into each of the four flow path opening sections 247 may be a separate body from the flow path member 250 and the holder 230. The separate body from the flow path member 250 and the holder 230 is, for example, a spacer that adjusts a space between the flow path member 250 and the holder 230.

As understood from FIG. 7, the signal wiring SL and the normal ground wiring GND2 are not disposed in the upper and lower layers in which the grounding ground wiring GND1 is disposed. As understood from FIG. 6, the integrated circuit 241 is disposed on the opposite side of the grounding ground wiring GND1 in plan view. Specifically, in plan view, the integrated circuit 241 is disposed in the Y1 direction with respect to a center of gravity G1 of the wiring substrate 240 in plan view, and the grounding ground wiring GND1 is disposed in the Y2 direction with respect to the center of gravity G1. The center of gravity is a point at which the sum of the first moments of area of a target shape is zero. By the integrated circuit 241 being separated from the grounding ground wiring GND1, it is possible to prevent the integrated circuit 241 from being affected by noise caused by the static electricity.

Further, the wiring substrate 240 includes a signal wiring SL3. The signal wiring SL3 has a wiring part SL3_1, a through-hole wiring SL3_2, and a wiring part SL3_3. The wiring part SL3_1 is a wiring for transmitting an electric signal between the connector 243_2 of the first insulator layer 245a and the through-hole wiring SL3_2. The through-hole wiring SL3_2 is disposed along a through-hole 242d penetrating the wiring substrate 240. The wiring part SL3_3 is disposed on the surface of the fourth insulator layer 245d in the Z2 direction. In FIG. 6, since the wiring substrate 240 is viewed in the Z2 direction, the wiring part SL3_3 is not visible, but the wiring part SL3_3 is displayed by a one-dot chain line for the sake of convenience. As understood from FIG. 6, it is preferable that the through-hole wiring SL3_2 is disposed away from the grounding ground wiring GND1.

### 1-6. About Route Through which Static Electricity is Transmitted

In FIG. 7, a route RT to the base 91, in a route through which the static electricity is transmitted when the static electricity is generated on the ejection surface SN, is illustrated. The route RT reaches the base 91 which is the frame ground through the head cover 210, the grounding spring SP2, the grounding spring abutting section 248b, the grounding ground wiring GND1, the grounding spring abutting section 248a, and the grounding spring SP1.

### 1-7. Summary of First Embodiment

The liquid ejecting head 200 according to the first embodiment includes the six head chips 220 including the plurality of nozzles N for ejecting the ink and the plurality of piezoelectric elements 220f for causing the plurality of nozzles N to eject the ink, the conductive head cover 210 for exposing the plurality of nozzles N to the outside, and the wiring substrate 240 on which the integrated circuit 241 is mounted. The wiring substrate 240 includes the grounding ground wiring GND1 that is electrically coupled to the head cover 210 without being electrically coupled to the upper electrode Zu of the piezoelectric element 220f, and the normal ground wiring GND2 that is electrically coupled to the integrated circuit 241. The grounding ground wiring GND1 and the normal ground wiring GND2 are electrically separated from each other in the wiring substrate 240.

According to the first embodiment, even when the static electricity generated in the head cover 210 flows through the grounding ground wiring GND1, the static electricity does not reach the normal ground wiring GND2 that is electrically separated from the grounding ground wiring GND1, so that it is possible to prevent the integrated circuit 241 from failing.

The wiring substrate 240 includes 12 or more signal wirings SL, and the grounding ground wiring GND1 does not overlap the plurality of signal wirings SL and the normal ground wiring GND2 in plan view.

In the first embodiment, in plan view, the grounding ground wiring GND1 is disposed away from the plurality of signal wirings SL and the normal ground wiring GND2 as compared with an aspect in which the grounding ground wiring GND1 overlaps the plurality of signal wirings SL and the normal ground wiring GND2. Generally, the static electricity is a high voltage, and when the voltage is high, there is a possibility that insulation breakdown occurs and a short circuit occurs. As the two wirings are separated, the possibility that the two wirings are short-circuited is reduced. According to the first embodiment, it is possible to prevent the static electricity from flowing through the normal ground wiring GND2 as compared with an aspect in which the grounding ground wiring GND1 overlaps the plurality of signal wirings SL and the normal ground wiring GND2.

It is preferable that, in plan view, the shortest distance between the grounding ground wiring GND1 and the wiring, which is adjacent to the grounding ground wiring GND1, among the plurality of signal wirings and the normal ground wiring GND2 is 4 mm or more. As a result, it is possible to prevent the signal wiring SL and the normal ground wiring GND2 from being affected by the noise caused by the static electricity. More preferably, the shortest distance is 5 mm or more, 6.3 mm or more, 8 mm or more, and 10 mm or more, with the latter being more preferred. According to the first embodiment, even when the execution operation voltage of the static electricity is relatively large, the influence of the noise can be reduced.

The wiring substrate 240 includes the flow path opening section 247_2 that penetrates along the thickness direction and that is disposed between the grounding ground wiring GND1 and the normal ground wiring GND2, which is disposed on the surface of the fourth insulator layer 245d in the Z1 direction and a wiring adjacent to the grounding ground wiring GND1, among the 12 or more signal wirings SL and the normal ground wiring GND2 when viewed in the thickness direction.

According to the first embodiment, by including the flow path opening section 247_2, it is possible to prevent the signal wiring SL and the normal ground wiring GND2 from being affected by the noise caused by the static electricity.

The liquid ejecting head 200 further includes the flow path member 250 including the flow path that is coupled to the flow paths of the six head chips 220, the wiring substrate 240 is disposed between the flow path member 250 and the plurality of head chips 220 in the direction along the Z-axis, and the coupling flow path FP_2 through which the six head chips 220 and the flow path member 250 communicate with each other is disposed inside the flow path opening section 247_2 in plan view.

According to the first embodiment, the space inside the flow path opening section 247_2 can be effectively utilized. By using the space inside the flow path opening section 247_2, the size of the liquid ejecting head 200 in an XY plane can be reduced as compared with an aspect in which the coupling flow path FP_2 is disposed outside the flow path member 250.

The grounding ground wiring GND1 is a ground wiring for being electrically coupled to the frame ground outside the liquid ejecting head 200, and the normal ground wiring GND2 is a wiring for constituting a part of the signal ground.

In addition, the normal ground wiring GND2 has the wiring part GND21 having the width D2 larger than the width D1 of the grounding ground wiring GND1.

In addition, the wiring substrate includes the grounding spring SP1 that electrically couples the grounding ground wiring GND1 of the wiring substrate and the frame ground.

The liquid ejecting apparatus 100 according to the present embodiment includes the liquid ejecting head 200 and the power supply circuit 2 that generates, from the power supply, the reference potential signal VBS1, which is a signal of the reference potential that flows through the normal ground wiring GND2 constituting a part of the signal ground.

### 2. Modification Example

Each of the above-described forms can be variously modified. Specific modification aspects that can be applied to each of the above-described forms will be described below. Any two or more aspects selected from the examples described below can be combined as appropriate as long as there is no contradiction.

### 2-1. First Modification Example

A first modification example is different from the first embodiment in that a region in which the grounding ground wiring GND1 overlaps the plurality of signal wirings or the normal ground wiring GND2 is present in plan view. Hereinafter, the first modification example will be described.

FIG. 8 is a diagram illustrating a wiring substrate 240A according to the first modification example. FIG. 8 illustrates a cross-sectional view of the wiring substrate 240A cut along the line VII-VII in FIG. 6. In FIG. 8, a part of the holder 230 is also illustrated in addition to the wiring substrate 240A. As illustrated in FIG. 8, the wiring substrate 240A is formed by stacking a first insulator layer 245aA, a second insulator layer 245bA, and a third insulator layer 245cA in this order along the Z-axis. Hereinafter, the first insulator layer 245aA, the second insulator layer 245bA, and the third insulator layer 245cA may be referred to as an insulator layer 245A without distinction. As described above, the number of the insulator layers 245A included in the wiring substrate 240A and the number of the insulator layers 245 included in the wiring substrate 240 are different from each other.

The wiring substrate 240A includes a grounding ground wiring GND1A instead of the grounding ground wiring GND1. The grounding ground wiring GND1A has the wiring part GND11, a through-hole wiring GND12A, and a wiring part GND13A. The through-hole wiring GND12A is disposed along a through-hole 242bA penetrating the wiring substrate 240A, specifically, the three insulator layers 245A along the Z-axis. The wiring part GND13A is disposed along the X-axis on a surface of the third insulator layer 245c facing the Z2 direction. An end of the wiring part GND13A in the X1 direction is located in the vicinity of the center in the width of the wiring substrate 240A in the direction along the X-axis.

Further, the wiring substrate 240A includes a plurality of signal wirings SLA. Specifically, in the example illustrated in FIG. 8, the plurality of signal wirings SLA include a signal wiring SLA_1, a signal wiring SLA_2, a signal wiring SLA_3, a signal wiring SLA_4, a via wiring SLA_5, and a via wiring SLA_6. Hereinafter, the signal wiring SLA included in the wiring substrate 240A may be simply referred to as the signal wiring SLA. The wiring substrate 240A may include a signal wiring SLA (not illustrated) in addition to the signal wiring SLA illustrated in FIG. 8. However, in FIG. 8, in order to prevent the drawing from being complicated, when viewed in the Y1 direction, the signal wiring SL located in the Y1 direction with respect to the line VII-VII is omitted from the illustration. A part or all of the signal wirings SLA illustrated in FIG. 8 may be the normal ground wiring GND2.

The signal wiring SLA_1 is disposed on a surface of the first insulator layer 245aA facing the Z1 direction and in the X1 direction with respect to the wiring part GND11. The signal wiring SLA_2 and the signal wiring SLA_3 are disposed between the first insulator layer 245aA and the second insulator layer 245bA. The signal wiring SLA_2 is disposed in the X1 direction with respect to the through-hole wiring GND12A. The signal wiring SLA_3 is disposed in the X1 direction with respect to the signal wiring SLA_2. The signal wiring SLA_4 is disposed on a surface of the third insulator layer 245cA facing the Z2 direction and in the X1 direction with respect to the wiring part GND13A. The via wiring SLA_5 is a wiring for making the signal wiring SLA_1 and the signal wiring SLA_4 conductive, and is disposed along a through-hole 242f penetrating the wiring substrate 240A along the Z-axis. The via wiring SLA_6 is a wiring for making the signal wiring SLA_1 and the signal wiring SLA_2 conductive, and is disposed along a through-hole 242g penetrating the first insulator layer 245aA and the second insulator layer 245aB along the Z-axis. Similar to the through-hole, the via is a through-hole penetrating the multilayer substrate, and is provided between the plurality of insulator layers included in the multilayer substrate or between two wirings provided on any of both surfaces of the multilayer substrate to make the two wirings conductive. However, it is also possible to penetrate a part of the insulator layers among the plurality of insulator layers included in the multilayer substrate through the via, as in the through-hole 242g.

A region RGND illustrated in FIG. 8 is a region indicating the vicinity of the through-hole wiring GND12A. As illustrated by the region RGND, the signal wiring SLA and the normal ground wiring GND2 are not disposed in the vicinity of the through-hole wiring GND12A included in the grounding ground wiring GND1A. In addition, a region RSL1 illustrated in FIG. 8 is a region indicating the vicinity of the via wiring SLA_5. As illustrated by the region RSL1, the grounding ground wiring GND1A is not disposed in the vicinity of the signal wiring SLA or the normal ground wiring GND2.

As understood from FIG. 8, a region RSL2 illustrated in FIG. 8 is a region in which the grounding ground wiring GND1A overlaps the signal wiring SLA_1 and the signal wiring SLA_2 in plan view. When the region RSL2 is viewed in the Y1 direction, two insulator layers 245A, that is, the second insulator layer 245bA and the third insulator layer 245cA among the three insulator layers 245A are present between the grounding ground wiring GND1A and the signal wiring SLA_1 and the signal wiring SLA_2. The Y1 direction is an example of a “direction perpendicular to the thickness direction of the wiring substrate”. None of the plurality of signal wirings SLA and the normal ground wiring GND2 included in the wiring substrate 240A are present between the two insulator layers 245A. Since none of the plurality of signal wirings SLA and the normal ground wiring GND2 of the wiring substrate 240A are present between the two insulator layers 245A, the signal wiring SLA or the normal ground wiring GND2 can be prevented from being affected by the noise caused by the static electricity as compared with an aspect in which the signal wiring SLA or the normal ground wiring GND2 is present between the two insulator layers 245A. However, in the first modification example, when the region RSL2 is viewed in the Y1 direction, the two insulator layers 245A are present between the grounding ground wiring GND1A and the signal wiring SLA_1 and the signal wiring SLA_2, but the present disclosure is not limited to this. When the region RSL2 is viewed in the Y1 direction, the number of the insulator layers 245A present between the grounding ground wiring GND1A and the signal wiring SLA_1 and the signal wiring SLA_2 is more preferably three than two, and still more preferably four.

### 2-2. Second Modification Example

A second modification example is different from the first embodiment and the first modification example in that the grounding spring SP2 abuts on the head cover 210 through the inside of the holder 230. Hereinafter, the second modification example will be described.

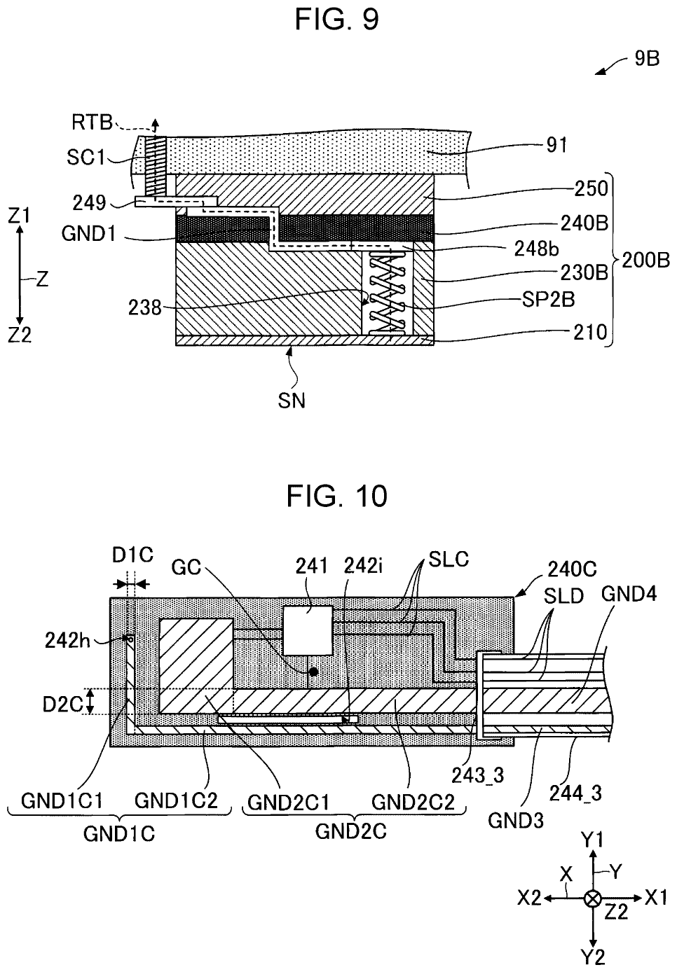

FIG. 9 is a diagram illustrating a head module 9B according to the second modification example. The head module 9B is different from the head module 9 in that the head module 9B includes a liquid ejecting head 200B instead of the liquid ejecting head 200, and includes a fastening screw SC1 instead of the grounding spring SP1. The liquid ejecting head 200B is different from the liquid ejecting head 200 in that the liquid ejecting head 200B includes a holder 230B instead of the holder 230 and includes a wiring substrate 240B instead of the wiring substrate 240.

The holder 230B is different from the holder 230 in that the holder 230B includes a through-hole 238 for inserting a grounding spring SP2B in the second modification example. The grounding spring SP2B is disposed inside the holder 230B.

The wiring substrate 240B is different from the wiring substrate 240 in that the wiring substrate 240B includes a screw receiving section 249 instead of the grounding spring abutting section 248a. The screw receiving section 249 has a screw hole (not illustrated) on a surface facing the Z1 direction, and the liquid ejecting head 200B is fixed to the base 91 by inserting and screwing the fastening screw SC1 into the screw hole. The screw receiving section 249 and the fastening screw SC1 are formed of a conductive material such as metal.

FIG. 9 illustrates a route RTB through which the static electricity is transmitted when the static electricity is generated on the ejection surface SN. The route RTB reaches the base 91 through the head cover 210, the grounding spring SP2B, the grounding spring abutting section 248b, the grounding ground wiring GND1, the screw receiving section 249, and the fastening screw SC1.

As described above, according to the second modification example, the plurality of head chips 220 is fixed to the head cover 210, and the liquid ejecting head 200 further includes the holder 230 that accommodates the plurality of head chips 220 between the head cover 210 and the holder 230, and the grounding spring SP2B that is a conductive member disposed inside the holder 230 to electrically couple the head cover 210 and the grounding ground wiring GND1 of the wiring substrate 240.

According to the second modification example, it is possible to reduce the size of the periphery of the head cover 210 as compared with an aspect in which the grounding spring SP2B is provided outside the head cover 210. For example, at the design stage of the holder 230B, when there is a gap between the plurality of head chips 220 accommodated in the holder 230B, the second modification example can be applied by inserting the grounding spring SP2B into the gap.

### 2-3. Third Modification Example

A third modification example is different from the first embodiment, the first modification example, and the second modification example in that the grounding ground wiring GND1 and the normal ground wiring GND2 are electrically coupled to the wiring member. Hereinafter, the third modification example will be described.

FIG. 10 is a diagram illustrating a wiring substrate 240C according to the third modification example. The wiring substrate 240C is different from the wiring substrate 240 in that the wiring substrate 240C includes a grounding ground wiring GND1C instead of the grounding ground wiring GND1, includes a normal ground wiring GND2C instead of the normal ground wiring GND2, includes a connector 243_3 instead of the connector 243_1 and the connector 243_2, and includes a signal wiring SLC instead of the plurality of signal wirings SL. In order to prevent the drawing from being complicated, in the wiring substrate 240C, the opening through which the wiring member 220i of the head chip 220 is inserted and the terminal group electrically coupled to the wiring member 220i are not illustrated. In addition, in FIG. 10, a portion of the insulator in the wiring substrate 240C is illustrated by applying thin hatching. The wiring substrate 240C may be a multilayer substrate or may be a double-sided substrate having a circuit pattern on both surfaces of one substrate.

As illustrated in FIG. 10, a wiring member 244_3, which is electrically coupled to the relay substrate 97, is detachably coupled to the connector 243_3. The wiring member 244_3 is formed of a flexible substrate, similar to the wiring member 244_1 and the wiring member 244_2. The wiring member 244_3 includes three signal wirings SLD, a grounding ground wiring GND3, and a normal ground wiring GND4. The grounding ground wiring GND3 is an example of a “third ground wiring”, and the normal ground wiring GND4 is an example of a “fourth ground wiring”. In FIG. 10, the grounding ground wiring GND3 and the grounding ground wiring GND1C are shaded with oblique lines from an upper left to a lower right. The normal ground wiring GND4 and the normal ground wiring GND2C are shaded with oblique lines from an upper right to a lower left.

As illustrated in FIG. 10, the grounding ground wiring GND1C has a wiring part GND1C1 and a wiring part GND1C2. The wiring part GND1C1 is located at an end portion of the wiring substrate 240C in the X2 direction and is disposed to extend along the Y-axis. A through-hole 242h penetrating the wiring substrate 240 is provided at an end portion of the wiring part GND1C1 in the Y1 direction, and a through-hole wiring is provided along the through-hole 242h. Although not illustrated, a grounding spring abutting section that abuts on the grounding spring SP1 is provided on a surface of the wiring substrate 240C facing the Z2 direction, and the grounding spring abutting section is directly coupled to the through-hole wiring provided along the through-hole 242h in a state where the power can be supplied. An end portion of the wiring part GND1C1 in the Y2 direction is directly coupled to the wiring part GND1C2 in a state where the power can be supplied.

The wiring part GND1C2 is located at an end portion of the wiring substrate 240C in the Y2 direction and is disposed to extend along the X-axis. An end portion of the wiring part GND1C2 in the X1 direction is electrically coupled to the grounding ground wiring GND3 through the connector 243_3.

The normal ground wiring GND2C is disposed inside the grounding ground wiring GND1C in the wiring substrate 240C. Specifically, the normal ground wiring GND2C has a wiring part GND2C1 and a wiring part GND2C2. The wiring part GND2C1 extends along the Y-axis and is disposed between a center of gravity GC of the wiring substrate 240C in plan view and the wiring part GND1C1. An end portion of the wiring part GND2C1 in the Y2 direction is directly coupled to the wiring part GND2C2 in a state where the power can be supplied. The wiring part GND2C2 extends along the X-axis and is disposed between the center of gravity GC and the wiring part GND1C2. In addition, a through-hole 242i penetrating the wiring substrate 240C is provided between the wiring part GND2C2 and the wiring part GND1C2. An end portion of the wiring part GND2C2 is electrically coupled to the normal ground wiring GND4 through the connector 243_3.

Each of the three signal wirings SLC is electrically coupled to any one of the three signal wirings SLD through the connector 243_3.

As in the first embodiment, it is preferable that the grounding ground wiring GND1C is disposed away from the plurality of signal wirings SLC and the normal ground wiring GND2C. As in the wiring member 244_3, it is preferable that the grounding ground wiring GND3 is disposed away from the plurality of signal wirings SLD and the normal ground wiring GND4. As a result, the grounding ground wiring GND3 is electrically separated from the plurality of signal wirings SLD, and the normal ground wiring GND4. Further, by providing the through-hole 242i between the wiring part GND2C2 and the wiring part GND1C2, it is possible to prevent the signal wiring SLC and the normal ground wiring GND2C from being affected by the noise caused by the static electricity, as compared with an aspect in which the through-hole 242i is not provided.

In addition, a width D2C of the normal ground wiring GND2 is larger than a width D1C of the grounding ground wiring GND1C. A width of the normal ground wiring GND4 is also larger than a width of the grounding ground wiring GND3.

As described above, in the third modification example, the grounding ground wiring GND1C is electrically coupled to the grounding ground wiring GND3 provided in the wiring member 244_3 electrically coupled to the wiring substrate 240C, and the normal ground wiring GND2C is electrically coupled to the normal ground wiring GND4 that is provided in the wiring member 244_3 and that is different from the grounding ground wiring GND3.

According to the third modification example, since the first embodiment need not include the grounding spring SP1, which is the conductive member for electrically coupling the wiring substrate 240C and the frame ground, the number of components of the liquid ejecting head 200 can be reduced.

### 2-4. Fourth Modification Example

In the third modification example, the grounding ground wiring GND3 provided in the wiring member 244_3 is electrically coupled to the frame ground, but the present disclosure is not limited to this. For example, when the width of the normal ground wiring GND4 provided in the wiring member 244_3 is sufficiently large, the grounding ground wiring GND3 and the normal ground wiring GND4 may be coupled to each other. The grounding ground wiring GND1C and the normal ground wiring GND2C are indirectly coupled to each other through a conductor having a sufficiently large volume, such as the normal ground wiring GND4, and thus a condition in which the grounding ground wiring GND1C and the normal ground wiring GND2C are electrically separated from each other is satisfied. In a fourth modification example, both the grounding ground wiring GND1C and the normal ground wiring GND2C are a part of the signal ground. The reference potential signal VBS1 is supplied from the power supply circuit 2 to the grounding ground wiring GND1C and the normal ground wiring GND2C.

### 2-5. Fifth Modification Example

In the aspects other than the fourth modification example of the above-described aspects, the grounding ground wiring GND1 is electrically coupled to the frame ground. In addition, the grounding ground wiring GND1 may be a part of the signal ground, and the normal ground wiring GND2 may be electrically coupled to the frame ground. Further, as described in the first embodiment, the grounding ground wiring GND1 and the normal ground wiring GND2 may be electrically coupled to the frame ground. The reference potential signal VBS1 may be supplied from the power supply circuit 2 to the ground wiring coupled to the frame ground.

### 2-6. Sixth Modification Example

In the aspects other than the third modification example and the fourth modification example among the above-described aspects, the grounding ground wiring GND1 may be a part of the signal ground, and the normal ground wiring GND2 may be electrically coupled to the frame ground. The reference potential signal VBS1 may be supplied from the power supply circuit 2 to the grounding ground wiring GND1.

### 2-7. Seventh Modification Example

Although the head cover 210 in each of the above-described aspects fixes the plurality of head chips 220, the head cover 210 may simply accommodate the plurality of head chips 220 without fixing the plurality of head chips 220.

### 2-8. Eighth Modification Example

In each of the above-described aspects, a heat generation element may be used as an energy generation element that generates energy in the pressure chamber CV for ejecting the ink, instead of the piezoelectric element 220f used in each of the above-described aspects.

### 2-9. Ninth Modification Example

In each of the above-described aspects, the frame ground outside the liquid ejecting head 200 is described as the base 91, but the frame ground outside the liquid ejecting head 200 is not limited to the base 91. For example, the frame ground outside the liquid ejecting head 200 may be a housing of the liquid ejecting apparatus 100. The static electricity that has reached the base 91 reaches the housing of the liquid ejecting apparatus 100, which is the frame ground, through the screw member 955, the base cover 95, and the conductive spring (not illustrated) that couples the base cover 95 and the housing of the liquid ejecting apparatus 100.

### 2-10. Tenth Modification Example

In each of the above-described aspects, the serial type liquid ejecting apparatus in which the carriage 71 in which the head module 9 is mounted is reciprocated is described as an example, but the present disclosure can also be applied to a line type liquid ejecting apparatus in which a plurality of nozzles N are distributed over the entire width of the medium PP.

### 2-11. Other Modification Examples

The liquid ejecting apparatus described above can be adopted in various types of equipment such as a facsimile machine and a copier, in addition to a machine dedicated to printing. However, the application of the liquid ejecting apparatus of the present disclosure is not limited to the printing. For example, a liquid ejecting apparatus that ejects a solution of a coloring material is used as a manufacturing apparatus that forms a color filter of a liquid crystal display device. In addition, a liquid ejecting apparatus that ejects a solution of a conductive material is used as a manufacturing apparatus that forms wirings and electrodes of a wiring substrate.

### 3. Supplementary Note

From the embodiments described above, for example, the following configurations can be understood.

Aspect 1 as a preferred aspect relates to a liquid ejecting head including: a liquid ejecting section including a plurality of nozzles for ejecting a liquid and a plurality of drive elements for causing the plurality of nozzles to eject the liquid; a conductive head cover for exposing the plurality of nozzles to an outside; and a wiring substrate on which an integrated circuit is mounted, in which the wiring substrate includes a first ground wiring that is electrically coupled to the head cover without being electrically coupled to an electrode of the drive element and a second ground wiring that is electrically coupled to the integrated circuit, and the first ground wiring and the second ground wiring are electrically separated from each other in the wiring substrate.

According to Aspect 1, even when the static electricity generated in the head cover flows through the first ground wiring, the static electricity does not reach the second ground wiring electrically separated from the first ground wiring, so that it is possible to prevent the integrated circuit from failing.

In Aspect 2 as a specific example of Aspect 1, the wiring substrate includes a plurality of signal wirings, and the first ground wiring does not overlap the plurality of signal wirings and the second ground wiring when viewed in a thickness direction of the wiring substrate.

According to Aspect 2, it is possible to prevent the static electricity from flowing through the normal ground wiring GND2 as compared with an aspect in which the grounding ground wiring GND1 overlaps the plurality of signal wirings SL and the normal ground wiring GND2.

In Aspect 3 as a specific example of Aspect 2, when viewed in the thickness direction, a shortest distance between the first ground wiring and a wiring, which is adjacent to the first ground wiring, among the plurality of signal wirings and the second ground wiring is 4 mm or more.

In Aspect 4 as a specific example of Aspect 2, the wiring substrate includes a through-hole that penetrates along the thickness direction and that is disposed between the first ground wiring and a wiring, which is adjacent to the first ground wiring, among the plurality of signal wirings and the second ground wiring when viewed in the thickness direction.

According to Aspect 4, by including the through-hole, it is possible to prevent the plurality of signal wirings and the second ground wiring from being affected by the noise caused by the static electricity.

In Aspect 5 as a specific example of Aspect 4, the liquid ejecting head further includes a flow path member including a flow path that is coupled to a flow path of the liquid ejecting section, the wiring substrate is disposed between the flow path member and the liquid ejecting section in the thickness direction, and a coupling flow path through which the liquid ejecting section and the flow path member communicate with each other is disposed inside the through-hole when viewed in the thickness direction.

According to Aspect 5, a space inside the through-hole can be effectively utilized.

In Aspect 6 as a specific example of Aspect 1, the wiring substrate includes a plurality of signal wirings and is a multilayer substrate including three or more insulator layers stacked in a thickness direction of the wiring substrate, when viewed in the thickness direction, a region in which the first ground wiring overlaps the plurality of signal wirings or the second ground wiring is present, when the region is viewed in a direction perpendicular to the thickness direction, two or more insulator layers among the three or more insulator layers are present between the first ground wiring and the plurality of signal wirings or the second ground wiring, and none of the plurality of signal wirings and the second ground wiring are present between two adjacent insulator layers among the two or more insulator layers.

According to Aspect 6, it is possible to prevent the signal wiring from being affected by the noise caused by the static electricity as compared with an aspect in which the signal wiring is present between the two adjacent insulator layers among the two or more insulator layers.

In Aspect 7 as a specific example of Aspect 1, the liquid ejecting section is composed of a plurality of head chips, the plurality of head chips are fixed to the head cover, and the liquid ejecting head further includes a holder that accommodates the plurality of head chips between the holder and the head cover, and a conductive member that is disposed inside the holder and that electrically couples the head cover and the first ground wiring of the wiring substrate.

According to Aspect 7, a size of the periphery of the head cover can be reduced as compared with an aspect in which the conductive member is provided outside the head cover.

In Aspect 8 as a specific example of Aspect 1, the first ground wiring is electrically coupled to a third ground wiring that is provided in a wiring member electrically coupled to the wiring substrate, and the second ground wiring is electrically coupled to a fourth ground wiring that is provided in the wiring member and that is different from the third ground wiring.

According to Aspect 8, it is not necessary to include the conductive member for electrically coupling the wiring substrate and the frame ground, so that the number of components of the liquid ejecting head can be reduced.

In Aspect 9 as a specific example of Aspect 1, the first ground wiring is a ground wiring for being electrically coupled to a frame ground outside the liquid ejecting head, and the second ground wiring is a wiring for constituting a part of a signal ground.

In Aspect 10 as a specific example of Aspect 9, the second ground wiring has a part having a width larger than a width of the first ground wiring.

In Aspect 11 as a specific example of Aspect 9, the liquid ejecting head further includes a conductive member that electrically couples the first ground wiring of the wiring substrate and the frame ground.

Aspect 12 as a preferred aspect relates to a liquid ejecting apparatus including: the liquid ejecting head according to any one of Aspects 1 to 8; and a generation circuit that generates, from a power supply, a signal of a reference potential that flows through a frame ground that is electrically coupled to at least one of the first ground wiring or the second ground wiring of the liquid ejecting head or at least one wiring of the first ground wiring or the second ground wiring of the liquid ejecting head, which constitutes a part of a signal ground.

Aspect 13 as a preferred aspect relates to a liquid ejecting apparatus including: the liquid ejecting head according to any one of Aspects 9 to 11; and a generation circuit that generates, from a power supply, a signal of a reference potential that flows through the frame ground that is electrically coupled to the first ground wiring of the liquid ejecting head or the second ground wiring of the liquid ejecting head, which is the wiring for constituting the signal ground.

What is claimed is:

1. A liquid ejecting head comprising:
a liquid ejecting section including a plurality of nozzles configured to eject a liquid and a plurality of drive elements for causing the plurality of nozzles to eject the liquid;
a conductive head cover for exposing the plurality of nozzles to an outside; and
a wiring substrate on which an integrated circuit is mounted, wherein
the wiring substrate includes a first ground wiring that is electrically coupled to the head cover without being electrically coupled to an electrode of the drive element and a second ground wiring that is electrically coupled to the integrated circuit, and
the first ground wiring and the second ground wiring are electrically separated from each other in the wiring substrate.

2. The liquid ejecting head according to claim 1, wherein
the wiring substrate includes a plurality of signal wirings, and
the first ground wiring does not overlap the plurality of signal wirings and the second ground wiring when viewed in a thickness direction of the wiring substrate.

3. The liquid ejecting head according to claim 2, wherein
when viewed in the thickness direction, a shortest distance between the first ground wiring and a wiring, which is adjacent to the first ground wiring, among the plurality of signal wirings and the second ground wiring is 4 mm or more.

4. The liquid ejecting head according to claim 2, wherein
the wiring substrate includes a through-hole that penetrates along the thickness direction and that is disposed between the first ground wiring and a wiring, which is adjacent to the first ground wiring, among the plurality of signal wirings and the second ground wiring when viewed in the thickness direction.

5. The liquid ejecting head according to claim 4, further comprising:
a flow path member including a flow path that is coupled to a flow path of the liquid ejecting section, wherein
the wiring substrate is disposed between the flow path member and the liquid ejecting section in the thickness direction, and
a coupling flow path through which the liquid ejecting section and the flow path member communicate with each other is disposed inside the through-hole when viewed in the thickness direction.

6. The liquid ejecting head according to claim 1, wherein
the wiring substrate includes a plurality of signal wirings and is a multilayer substrate including three or more insulator layers stacked in a thickness direction of the wiring substrate,
when viewed in the thickness direction, a region in which the first ground wiring overlaps the plurality of signal wirings or the second ground wiring is present,
when the region is viewed in a direction perpendicular to the thickness direction, two or more insulator layers among the three or more insulator layers are present between the first ground wiring and the plurality of signal wirings or the second ground wiring, and
none of the plurality of signal wirings and the second ground wiring are present between two adjacent insulator layers among the two or more insulator layers.

7. The liquid ejecting head according to claim 1, wherein
the liquid ejecting section is composed of a plurality of head chips,
the plurality of head chips are fixed to the head cover, and
the liquid ejecting head further comprises
a holder that accommodates the plurality of head chips between the holder and the head cover, and
a conductive member that is disposed inside the holder and that electrically couples the head cover and the first ground wiring of the wiring substrate.

8. The liquid ejecting head according to claim 1, wherein
the first ground wiring is electrically coupled to a third ground wiring that is provided in a wiring member electrically coupled to the wiring substrate, and
the second ground wiring is electrically coupled to a fourth ground wiring that is provided in the wiring member and that is different from the third ground wiring.

9. The liquid ejecting head according to claim 1, wherein
the first ground wiring is a ground wiring for being electrically coupled to a frame ground outside the liquid ejecting head, and
the second ground wiring is a wiring for constituting a part of a signal ground.

10. The liquid ejecting head according to claim 9, wherein
the second ground wiring has a part having a width larger than a width of the first ground wiring.

11. The liquid ejecting head according to claim 9, further comprising:
a conductive member that electrically couples the first ground wiring of the wiring substrate and the frame ground.

12. A liquid ejecting apparatus comprising:
the liquid ejecting head according to claim 1; and
a generation circuit that generates, from a power supply, a signal of a reference potential that flows through a frame ground that is electrically coupled to at least one of the first ground wiring or the second ground wiring of the liquid ejecting head or at least one wiring of the first ground wiring or the second ground wiring of the liquid ejecting head, which constitutes a part of a signal ground.

13. A liquid ejecting apparatus comprising:
the liquid ejecting head according to claim 9; and
a generation circuit that generates, from a power supply, a signal of a reference potential that flows through the frame ground that is electrically coupled to the first ground wiring of the liquid ejecting head or the second ground wiring of the liquid ejecting head, which is the wiring for constituting a part of the signal ground.
